(19) United States
(12) Patent Application Publication
(10) Pub. No.: US 2023/0122569 A1
(43) Pub. Date: Apr. 20, 2023

(54) NETWORK AWARENESS OF MULTI-UNIVERSAL SUBSCRIBER IDENTITY MODULE (MUSIM) DEVICES BY ASSISTANCE INFORMATION SIGNALING

(71) Applicant: CABLE TELEVISION LABORATORIES, INC., Louisville, CO (US)

(72) Inventors: SUNDAR R. SRIRAM, Aurora, IL (US); YUNJUNG YI, Vienna, VA (US)

(21) Appl. No.: 17/966,089

(22) Filed: Oct. 14, 2022

Related U.S. Application Data
(60) Provisional application No. 63/271,002, filed on Oct. 22, 2021.
(60) Provisional application No. 63/255,709, filed on Oct. 14, 2021.

(51) Int. Cl. H04W 68/02; H04W 8/24; H04W 76/27

(52) U.S. Cl. CPC H04W 68/02; H04W 8/24; H04W 76/27; H04W 88/06

(57) ABSTRACT

Systems, methods, and devices include techniques for improving network resource usage for a multi-universal subscriber identity module (MUSIM) device in a multi-network environment. A wireless device can send to a network function of a network (e.g., an Access and Mobility Management Function (AMF) or a Mobility Management Entity (MME) an indication that the wireless device is a MUSIM device. The indication can be included in a UE capability information message of an attach procedure and/or a UE assistance information message of a UE assistance information capability procedure, as defined by 3GPP standards. Upon sending the indication, the wireless device can receive a response message indicating that the network supports various MUSIM features of the MUSIM device. The wireless device can receive a paging offset request from the network function. Accordingly, the wireless device can change a device parameter associated with the network (e.g., a paging offset value).

### CROSS-REFERENCE TO RELATED APPLICATION

This application claims priority under 35 U.S.C. § 119 to U.S. Provisional Patent Application No. 63/271,002, titled “NETWORK AWARENESS OF MULTI-USIM(MUSIM) DEVICES BY UE ASSISTANCE INFORMATION SIGNALING” and filed Oct. 22, 2021, U.S.; and U.S. Provisional Patent Application No. 63/255,709, titled “NETWORK AWARENESS OF MULTI-USIM(MUSIM) DEVICES BY UE ASSISTANCE INFORMATION SIGNALING” and filed Oct. 14, 2021, the entireties of which are incorporated herein by reference.

### BACKGROUND

Many wireless devices (e.g., smartphones) support more than one subscriber identity module (SIM) card. For instance, a user can have both a personal subscription and a business subscription supported on a single device. In another use case, the user has multiple personal subscriptions and chooses which one to use based on the selected service (e.g., one for data and another for voice). The two SIMs may be from the same or from different Mobile Network Operators.

However, a network attempting to page a multi-SIM device sometimes will not receive a response from the multi-SIM device because the multi-SIM device is operating with the SIM of the other network. Although some techniques have been developed to notify a network node of the multiple SIM functionality, such as those discussed in U.S. Pat. No. 9,474,105, these techniques require sending additional transmit chains and receive chains, which may not be supported in certain multi-network environments. In some instances, previous techniques decrease network inefficient by requiring additional message transmissions.

It is with these observations in mind, among others, that the presently disclosed technology was conceived.

### BRIEF SUMMARY

The aforementioned problems can be addressed using the systems, methods, and devices disclosed herein. For instance, a method can include sending, by a wireless device to one or more network functions (NF)s of a network, one or more indication that the wireless device is a multi-universal subscriber identity module (MUSIM) device. The one or more indication can include at least one of a user equipment (UE) capability information message of an attach procedure; or a UE assistance information message of a UE assistance information capability procedure. Moreover, the method can include receiving, at the wireless device and responsive to the one or more indication, a paging offset request. Additionally or alternatively, the method can include changing, at the wireless device and responsive to the paging offset request, a paging offset value.

In some examples, the method further includes receiving, at the wireless device and from the one or more NFs, a response message indicating that a MUSIM feature of the MUSIM device is supported by the network. Additionally, the one or more indication can include one or more predefined information elements (IE) of the UE capability information message having one or more predefined values. The one or more indication can include a request to activate one or more MUSIM features including at least one of: a connection release request, a paging cause indication support, a reject paging request, paging restriction information, or a paging offset value. For instance, the one or more indication can include the connection release request to be released to an ECM-IDLE state for one of two USIMS of the wireless device. In some instances, the connection release request is based on the wireless device initiating a Service Request procedure or a Tracking Area Update procedure. Also, the one or more indication can be a first indication of a MUSIM feature being supported by the wireless device; and/or the method can further include: changing, at the wireless device, one or more device parameters causing a first USIM to be active and a second USIM to be inactive; and/or sending, in response to causing the first USIM to be active, a second indication, to the one or more NFs, that that the MUSIM feature is not supported by the wireless device. Moreover, the MUSIM feature can be at least one of a Connection Release feature, a Paging Cause Indication for Voice Service feature, a Reject Paging Request feature, or a Paging Restrictions Feature.

In some instances, a method can include sending, by a wireless device to at least one of an Access and Mobility Management Function (AMF) or a Mobility Management Entity (MME), one or more indication that the wireless device is a MUSIM device. The one or more indication can be included in at least one of: a UE capability information message of an attach procedure; or a UE assistance information message of a UE assistance information capability procedure. Additionally, the method can include receiving, at the wireless device and responsive to the one or more indication, one or more response messages indicating that the AMF or the MME supports a MUSIM feature of the MUSIM device.

In some scenarios, the one or more response messages are responsive to at least one of: a connection release request; an indication Paging Cause Indication for Voice Service is supported; a paging request rejection; a requested international mobile subscriber identity (IMSI) Offset value; or an indication Paging Restriction is supported. The method can further include changing, at the wireless device, a paging offset value at least partly based on the one or more response messages. The one or more indication can include a requested international mobile subscriber identity (IMSI) offset value. Moreover, the method can further include receiving, from the one or more NFs, an accepted IMSI offset value, the accepted IMSI offset value being different than the requested IMSI offset value. Furthermore, the one or more NFs can include a gNodeB. Also, sending the one or more indication can be at least part of an evolved universal terrestrial radio access network (EUTRAN) initial attach procedure.

In some examples, a method includes receiving, by at least one of an AMF or an MME of a network, one or more indication that a wireless device is a MUSIM device. The one or more indication can be included in at least one of: a UE capability information message of an attach procedure; or a UE assistance information message of a UE assistance information capability procedure. The method can also include storing, responsive to the one or more indication, a device identifier, corresponding to the wireless device, associated with a MUSIM feature; and/or sending, to the wireless device, an indication that the MUSIM feature is supported by the network.

In some instances, the one or more indication that the wireless device is a MUSIM device includes a request for a paging offset. Additionally, the method can further include sending, to the wireless device and responsive to the request for the paging offset, an accepted paging offset value. The method can further include receiving an initiation message for a Service Request Procedure or a Tracking Area Update, the initiation message omitting a release indication; and/or removing, from a database and in response to the initiation message omitting the release indication, Paging Restriction information associated with the wireless device. Moreover, the method can further comprise: sending, to the wireless device, a paging message; determining that the paging message is rejected by the wireless device; and/or storing, responsive to the paging message being rejected, and based on the device identifier corresponding to the wireless device being associated with the MUSIM feature, a record that the paging message is rejected due to the MUSIM feature. Additionally, the method can include categorizing a rejected message as a MUSIM-based message rejection, and/or performing a network performance measurement that categorizes message rejections into MUSIM-based message rejections and single USIM-based message rejections.

The foregoing summary is intended to be illustrative and is not meant in a limiting sense. Many features of the embodiments may be employed with or without reference to other features of any of the embodiments. Additional aspects, advantages, and/or utilities of the presently disclosed technology will be set forth in part in the description that follows and, in part, will be apparent from the description, or may be learned by practice of the presently disclosed technology.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate an implementation of systems, methods, and devices consistent with the disclosed subject matter and, together with the description, serves to explain advantages and principles consistent with the disclosed subject matter, in which:

FIG. 1 illustrates an example system including a multi-Universal Subscriber Identity Module (MUSIM) device in a multi-network environment;

FIG. 2 illustrates an example system including an evolved packet switching (EPS) attach procedure for a MUSIM device, which can form at least a portion of the system depicted in FIG. 1;

FIGS. 3A and 3B illustrate an example system including a user equipment (UE) capability information message and/or a UE capability match request message, which can form at least a portion of the system depicted in FIG. 1; and

FIGS. 4A and 4B illustrate an example system including a UE assistance information capability procedure, which can form at least a portion of the system depicted in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### Terminology

The phraseology and terminology employed herein are for the purpose of description and should not be regarded as limiting. For example, the use of a singular term, such as, “a” is not intended as limiting of the number of items. Further, it should be understood that any one of the features of the presently disclosed technology may be used separately or in combination with other features. Other systems, methods, features, and advantages of the presently disclosed technology will be, or become, apparent to one with skill in the art upon examination of the figures and the detailed description. It is intended that all such additional systems, methods, features, and advantages be included within this description, be within the scope of the presently disclosed technology, and be protected by the accompanying claims.

Further, as the presently disclosed technology is susceptible to embodiments of many different forms, it is intended that the present disclosure be considered as an example of the principles of the presently disclosed technology and not intended to limit the presently disclosed technology to the specific embodiments shown and described. Any one of the features of the presently disclosed technology may be used separately or in combination with any other feature. References to the terms “embodiment,” “embodiments,” and/or the like in the description mean that the feature and/or features being referred to are included in, at least, one aspect of the description. Separate references to the terms “embodiment,” “embodiments,” and/or the like in the description do not necessarily refer to the same embodiment and are also not mutually exclusive unless so stated and/or except as will be readily apparent to those skilled in the art from the description. For example, a feature, structure, process, step, action, or the like described in one embodiment may also be included in other embodiments, but is not necessarily included. Thus, the presently disclosed technology may include a variety of combinations and/or integrations of the embodiments described herein. Additionally, all aspects of the present disclosure, as described herein, are not essential for its practice. Likewise, other systems, methods, features, and advantages of the presently disclosed technology will be, or become, apparent to one with skill in the art upon examination of the figures and the description. It is intended that all such additional systems, methods, features, and advantages be included within this description, be within the scope of the presently disclosed technology, and be encompassed by the claims.

Any term of degree such as, but not limited to, “substantially,” as used in the description and the appended claims, should be understood to include an exact, or a similar, but not exact configuration. The terms “comprising,” “including” and “having” are used interchangeably in this disclosure. The terms “comprising,” “including” and “having” mean to include, but not necessarily be limited to the things so described.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

General Architecture

Systems, methods, and devices disclosed herein can address the aforementioned issues by using various communication procedures to inform a network of the UE's multi-SIM capabilities and supported enhancements. of the MUSIM functionalities and features of a UE.

Support for MUSIMs is sometimes handled in an implementation-specific manner without any support from 3GPP specifications, which can result in a variety of unstandardized implementations and UE behaviors. Examples include dual SIM single standby (DSSS), dual SIM dual standby (DSDS) and dual SIM dual active (DSDA). For cost efficiency reasons, a MUSIM device implementation sometimes uses common radio and baseband components that are shared among the MUSIMs. This can lead to several issues that impact the 3GPP system performance. For example, a MUSIM device that is actively engaged in communication with a 3GPP system may need to manage paging events and behavior potentially across two different mobile core networks. The impacts caused by dual SIM dual standby devices to the 3GPP system creates errors/noise in the 3GPP system's ability to measure network performance. The 3GPP system may not be able to determine if a message rejection or omission of a response is caused by a network error or by the MUSIM device being active on the other network's SIM.

Accordingly, the techniques disclosed herein can address these issues by providing information indicating MUSIM capabilities of the UE to the network during at least one of a UE attach procedure and/or a UE assistance information capability procedure. In response, the network can store an indication that the UE is the MUSIM (e.g., which can be used in network performance measurements), supports MUSIM feature(s), and/or the network can adjust one or more parameters with respect to the UE to facility multi-SIM functionality (e.g., by adjusting a paging offset value).

With the increased complexity of 5G-capable UEs, and with growing demand for MUSIM devices, the techniques disclosed herein can provide enhancements to 3GPP systems that create more cost-efficient implementations and uniform behavior in such devices. For instance, the techniques disclosed herein may provide enhancements based on 3GPP Release-17, such as Mobile Terminated service with a MUSIM device; enabling Paging Reception for MUSIM Device; and/or coordinated leaving for MUSIM device. These techniques can also improve the computing components of the network architecture by reducing the processing requirements, memory storage requirements, and/or power consumption requirements of the network devices (e.g., by incorporating MUSIM signaling into standardized attach procedures rather than using extraneous communication protocol), as discussed in greater detail below. Additionally or alternatively, operations of the 3GPP TS 23.401 (Section 4.3.33) may be modified or enhanced to perform the techniques disclosed herein, such as Connection release, as described in clause 4.3.33.2; Paging Cause Indication for Voice Service, as described in clause 4.3.33.3; Reject paging request, as described in clause 4.3.33.4; Paging timing collision control, as described in clause 4.3.33.5; and/or Paging Restriction, as described in clause 4.3.33.6.

Additional benefits and advantages of the disclosed technology will become apparent from the detailed description below

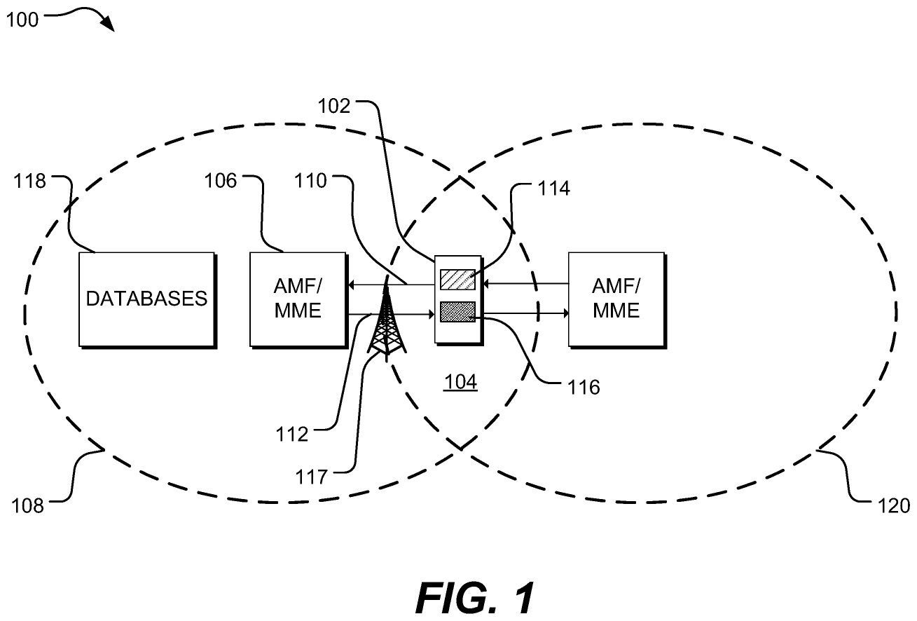

FIG. 1 illustrates an example network system 100 including a MUSIM UE 102 in a multi-network environment 104. Using the techniques disclosed herein (e.g., and/or a Tracking Area Update procedure), the MUSIM UE 102 can have more than one USIM active, and can support one or more MUSIM specific features as intended by a user for various uses. As discussed herein, the MUSIM UE 102 can send one or more indications corresponding to the supported MUSIM feature(s) to one or more network functions (NF)s, such as a first Access and Mobility Management Function (AMF)/Mobility Management Entity (MME) 106 of a first network 108 (e.g., a Fourth Generation (4G) network, a Fifth Generation (5G) network, or a Sixth Generation (6G) network).

In some examples, based on receiving an indication 110 of supported MUSIM features from the MUSIM UE 102, the first AMF/MME 106 can send a response message 112 to the MUSIM UE 102 indicating to the MUSIM UE 102 that the first network 108 supports at least some of the MUSIM features. For instance, the first AMF/MME 106 can send the response message 112 based on the MUSIM features being supported by first network 108 and/or any preference policy by the network 108, if available.

In some instances, the MUSIM UE 102 changes a device parameter to have only one USIM active. If the MUSIM UE 102 previously sent the indication 110 to the network 108 indicating supported MUSIM feature(s), the MUSIM UE 102 can send second indication to indicate that all the MUSIM features are not supported to the first network 102 for the MUSIM UE 102. For instance, the MUSIM UE 102 can send one or more indications indicating which MUSIM features are supported and which MUSIM features are unsupported to correspond to a status of the MUSIM UE 102 (e.g., which can change a plurality of times). The MUSIM UE 102 can include and/or indicate support of individual features for Connection release, Paging Cause Indication for Voice Service, Reject paging request and Paging Restrictions, as specified in clause 5.11.3. of 3GPP MUSIM Support standards. Furthermore, the first AMF/MME 106 can send one or more messages to the MUSIM UE 102 indicating that the first AMF/MME 106 supports a Paging Restriction feature and/or at least one of a Connection Release feature or a Reject Paging feature.

Furthermore, in some instances, the MUSIM UE 102 can use a separate international mobile equipment identity (IMEI) for the different USIMs when it registers to the network(s). The MUSIM UE 102 can send a first IMEI corresponding to a first USIM 114 to the first network 108 and/or a second IMEI corresponding to a second USIM 116 to a second network 120 (e.g., or the first network 108).

In some examples, the MUSIM UE 102 can send the one or more indications 110 as one or more requests for a MUSIM feature or parameter to be activated or deactivated. As discussed in greater detail below, the MUSIM UE 102 can include a connection release request, a paging cause indication support, a reject paging request, paging restriction information, a paging offset value, or combinations thereof. A radio access node (RAN) 117 of the first network 108 (e.g., an eNodeB, a gNodeB, a 6G RAN node, and/or so forth) can receive the one or more indications 110 and can determine that the MUSIM UE 102 has MUSIM capabilities or features based on the indication(s) 110.

In some instances, the MUSIM UE 102 can request a Connection Release, for instances, by requesting to be released to an ECM-IDLE state for one of the USIMs (e.g., the first USIM 114 or the second USIM 116) due to activity on the other USIM (e.g., the first USIM 114 or the second USIM 116). The Connection Release request can be sent based on a determination that both the MUSIM UE 102 and the first network 108 support this feature.

In some examples, the MUSIM UE 102 can send the request to be released to ECM-IDLE state for at least one of the USIMs by initiating the Service Request procedure (e.g., using Extended Service Request message) or a Tracking Area Update procedure. If the MUSIM UE 102 needs to perform Tracking Area Update with this network at the same time, the one or more indications 110 can include a Release Indication. If supported by the MUSIM UE 102 and the first network 108, the MUSIM UE 102 may also provide, together with the Release Indication, a Paging Restriction Information, as specified in clause 4.3.33.6, which requests the network to restrict paging. The Paging Restriction Information from the MUSIM UE 102 can be stored in the UE context in a database 118 of and/or accessed by the first AMF/MME 106. If no Paging Restriction Information is provided in the Extended Service Request or the Tracking Area Update Request, any stored Paging Restriction Information in the associated with the MUSIM UE 102 can be removed. In some scenarios, when the MUSIM UE 102 initiates a Service Request procedure or Tracking Area Update procedure for the first USIM 114 without providing a Release Indication, the first network 108 can remove any stored Paging Restriction Information associated with the first USIM 114 of the MUSIM UE 102 in response.

In some instances, the MUSIM UE 102 can send one or more indications 110 including a Paging cause indication for voice service, for instance, based on determining that the MUSIM UE 102 and the first network 108 support the Paging Cause Indication for Voice Service feature.

In some scenarios, the MME (e.g., MME 106) that supports Paging Cause Indication for Voice Service feature can provide (e.g., send) a Voice Service Indication in the S1AP Paging message (e.g., for the MMTel voice service) if the MUSIM UE 102 indicates the Paging Cause Indication for Voice Service feature is supported. The MME 106 can determine the downlink data triggering the paging is related to a multimedia telephony (MMTel) voice service based on the Paging Policy Indicator, included in the indication(s) 110 sent from the MUSIM UE 102, as specified in clause 4.9 for MMTel voice. In some scenarios, a circuit switched (CS) voice is indicated in the core network (CN) domain indication in S1AP paging message and Uu paging message, as existing functionality.

In some examples, upon reception of the Voice Service Indication in S1AP Paging Message, the access node, such as an eNodeB or gNodeB, that supports the Paging Cause Indication for Voice Service can include the Voice Service Indication in a Uu Paging message, sent from the eNodeB or gNodeB to the MUSIM UE 102. The RAN node 117 and/or the first AMF/MME 106 can store a record of the Paging Cause Indication for Voice Service associated with a device identifier for the MUSIM UE 102 (e.g., the NEI). The MUSIM UE 102 that supports the Paging Cause Indication for Voice Service feature can be capable of differentiation between Paging from a network that does support the Paging Cause Indication for Voice Service feature and Uu Paging (e.g., first network 108) and another network that does not support the Paging Cause Indication for Voice Service feature and Uu Paging without the Voice Service Indication (e.g., the second network 120). In some implementations, the RAN 117 can determine whether the MUSIM UE 102 supports or does not support Paging Cause Indication for Voice Service feature and Uu Paging (e.g., without the Voice Service Indication).

In some scenarios, the MUSIM UE 102 may respond to a page for a USIM (e.g., the first USIM 114 or the second USIM 116) from the first network 108 with a rejection of the paging request, or an indication to the MME 106 that the MUSIM UE 102 does not accept the paging, and/or requests to be released to ECM-IDLE state (e.g., in environments where both the MUSIM UE 102 and the first network 108 indicate this feature is supported). The MUSIM UE 102 can attempt to send a Service Request message to the paging network including the above indication as the response to the paging, unless the MUSIM UE 102 is unable to do so (e.g. due to UE implementation constraints). In addition to the Reject Paging Indication, the MUSIM UE 102 may include Paging Restriction Information as specified in clause 4.3.33.6 in the Service Request, if supported by UE and network. If no Paging Restriction Information is provided by the UE, any stored Paging Restriction Information in the UE context is removed by the MME. In some instances, the MUSIM UE 102 omits any response to the page for the USIM.

In some instances, the MUSIM UE 102 can send the indication 110 including a paging timing collision control request. For instance, to avoid possible paging occasion collision and to enhance the likelihood paging is received successfully for different USIMs, the MUSIM UE 102 may provide, for at least one USIM of the first USIM 114 and the second USIM 116, a Requested IMSI Offset value which can be used to determine paging occasions (e.g., timing or schedule). Upon reception of a Requested IMSI Offset value from the MUSIM UE 102 in an Attach Request or a Tracking Area Update Request, a supporting MME 106 can provide an Accepted IMSI Offset value to the MUSIM UE 102 in the Attach Accept or Tracking Area Update Accept message (e.g., sent from the AMF/MME 106 to the MUSIM UE 102) to acknowledge that the first network 108 supports the feature and to provide the accepted value. The Accepted IMSI Offset value can be stored in the UE context in the database 118 of the MME 106 (e.g., associated with the identifier for the MUSIM UE 102). The Accepted IMSI Offset value can be a different value from the Requested IMSI Offset provided by the MUSIM UE 102. If the MUSIM UE 102 does not provide any Requested IMSI Offset value in the Attach Request or the Tracking Area Request, the MME 106 can remove any stored IMSI Offset value in the UE context (e.g., stored at the database 118). The MUSIM UE 102 and the first network 108 can use the accepted IMSI Offset to determine the paging occasion. The MUSIM UE 102 and MME 106 can use the Accepted IMSI Offset value to calculate an alternative IMSI value that is determined based on the IMSI of the UE 102 as follows: alternative IMSI value=[MCC] [MNC] [(MSIN value+Accepted IMSI Offset) mod (MSIN address space)], where: the MCC, MNC and MSIN value are the fields of the UE's IMSI as defined in TS 23.003. An alternative IMSI value can be computed, as discussed above, and used instead of the IMSI stored in the USIM (e.g., the first USIM 114 and/or the second USIM 116) for at least one determination of a paging occasions as specified in TS 36.304 [34]. Additionally or alternative, the alternative IMSI value can be used to compute the UE Identity Index information the MME 106 sends to the RAN 117 (e.g., based on standard TS 36.413 [36]) for the RAN 117 to derive the paging occasions (e.g., according to TS 36.304 [4]).

In some examples, the MUSIM UE 102 and the network (e.g., the first network 108 an/or the second network 120) may support Paging Restriction. The MUSIM UE 102, in response to the MME 106 indicating that the network supports Paging Restriction feature, may indicate Paging Restriction Information in the Service Request, the Extended Service Request, and/or the Tracking Area Update Request (e.g., as specified in clauses 4.3.33.2 and 4.3.33.4). The Paging Restriction Information may indicate any of the following: all paging from the network to the MUSIM UE 102 is restricted; all paging is restricted except paging for voice service (MMTel voice or CS domain voice); all paging is restricted except for certain packet data network (PDN) Connection(s); all paging is restricted except for certain PDN Connection(s) and voice service (e.g., MMTel voice or CS domain voice). The first network 108 can determine that the MUSIM UE 102 is a multi-SIM device and/or can store the status of the MUSIM UE 102 as a multi-SIM device in the database 118 in response to any of these paging restriction requests discussed herein.

In some instances, the MUSIM UE 102 expects not to be paged for any purpose responsive to restricting all paging. The MUSIM UE 102 can expect to be paged only for voice service responsive to restricting all paging except voice services. The MUSIM UE 102 can expect to be paged only for certain PDN Connection(s) responsive to restricting all paging except certain PDN Connection(s). The MUSIM UE 102 can expect be paged for voice service and certain PDN Connection(s) responsive to restricting all paging except for voice service and certain PDN Connection(s). Additionally, in the case of roaming, the Paging Restrictions for voice service can depend on an existence of an agreement with the home public land mobile network (HPLMN) to support voice service via IMS. Hence the support of some of the paging restrictions can at least partially be based on the IMS voice service agreement.

In some instances, the first network 108 can store an indication of the USIM feature associated with the MUSIM UE 102 (e.g., the IMSI representing the MUSIM UE 102). Moreover, in scenarios, where the first network 108 does not receive a response to a paging message, the AMF/MME 106 can determine that the MUSIM UE 102 is associated with the USIM feature (e.g., based on the association stored at the database 118). Accordingly, the AMF/MME 106 can categorize errors and/or omissions of response from the MUSIM UE 102 as multi-SIM omissions, categorized differently than other response omissions for other single SIM UEs. In this way, a network performance measurement process and/or key performance indicator determination for the first network 108 can distinguish between errors or response omissions caused by a multi-SIM functionality as compared to errors or response omissions caused by other reasons (e.g., network errors or malfunctions).

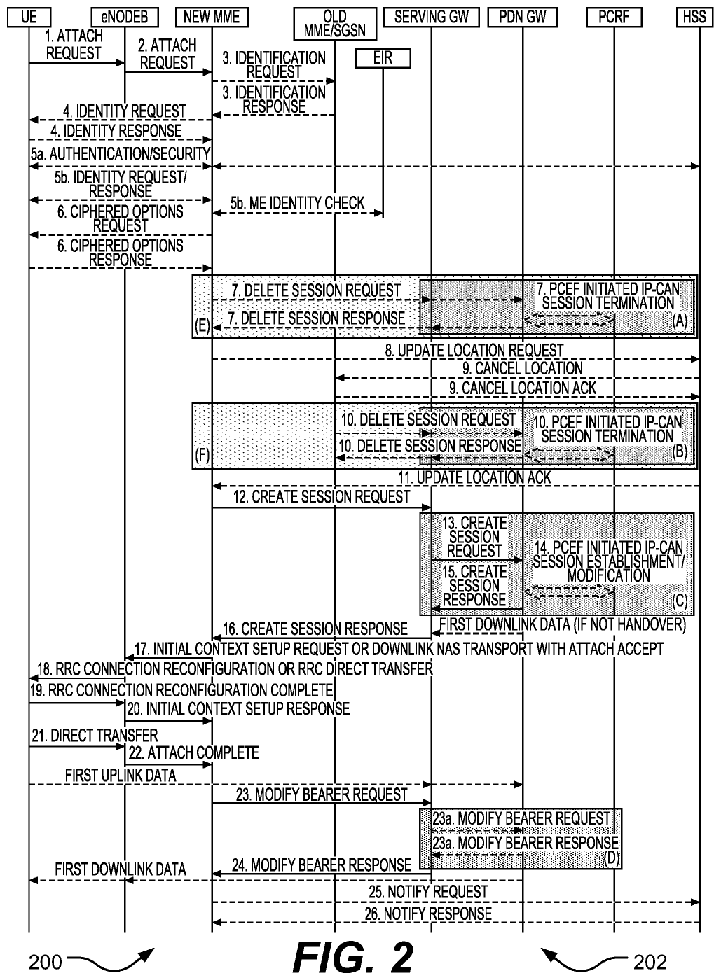

FIG. 2 illustrates an example system 200 including an evolved packet switching (EPS) Attach procedure 202 that can form at least a portion of the system 100 depicted in FIG. 1, for instance, to establish the multi-SIM functionality of the MUSIM UE 102 with the AMF/MME 106. In some examples, the attach procedure 202 can be based on 3GPP standard TS 23.401 Section 5.3.2 entitled “EUTRAN Initial Attach.”

In some examples, a UE/user (e.g., the MUSIM UE 102) registers with the network (e.g., the first network 108 and/or the second network 120) using the attach procedure 202 to receive services that require registration. This registration can be described as Network Attachment. The always-on connectivity for the MUSIM UE 102 of the EPS may be enabled by establishing a default EPS bearer during Network Attachment. The PCC rules applied to the default EPS bearer may be predefined in the PDN gateway (GVV) and activated in the attachment by the PDN GW itself. In some instances, this Attach procedure may trigger one or multiple Dedicated Bearer Establishment procedures to establish dedicated EPS bearer(s) for the MUSIM UE 102. During the attach procedure, the MUSIM UE 102 may request for an IP address allocation. During the Initial Attach procedure, the Mobile Equipment Identity can be obtained from the MUSIM UE 102 and/or stored as being associated with a MUSIM feature or status.

In some examples, the attach procedure 202 can include one or more of the operations, as shown FIG. 2. For instance, the attach procedure 202 can include achieving download/upload (DL/UL) sync via a signal synchronization block (SSB) decode and random access channel (RACHO Procedure. The attach procedure 202 can include signal radio bearer 0 (SRB0) establishment with radio resource control (RRC) Connection Request. Additionally, the attach procedure 202 can include Contention Resolution and SRB1 establishment with RRC setup. Additionally or alternatively, the MUSIM UE 102 can send a Registration Request. Moreover, the system 200 can perform one or more non-access stratum (NAS) Procedures, such as UE Identity transfer, Authentication and Security. The system 200 can also perform UE Capability transfer and AS security as part of the attach procedure 202. Moreover, SRB2 and DRB establishment can be performed as part of the attach procedure 202. Furthermore, Registration Complete and PDU session Establishment may be performed by the system 200 as part of the attach procedure 202. In some scenarios, any of the messages sent from the MUSIM UE 102 to the AMF/MME 106 during the Attach request procedure may indicate to the MME 106 a Requested Alternative IMSI Offset, with the aim of modifying the timing of the Paging Occasions to avoid paging collisions (e.g., or any of the other indication(s) 110 of multi-SIM functionality discussed herein).

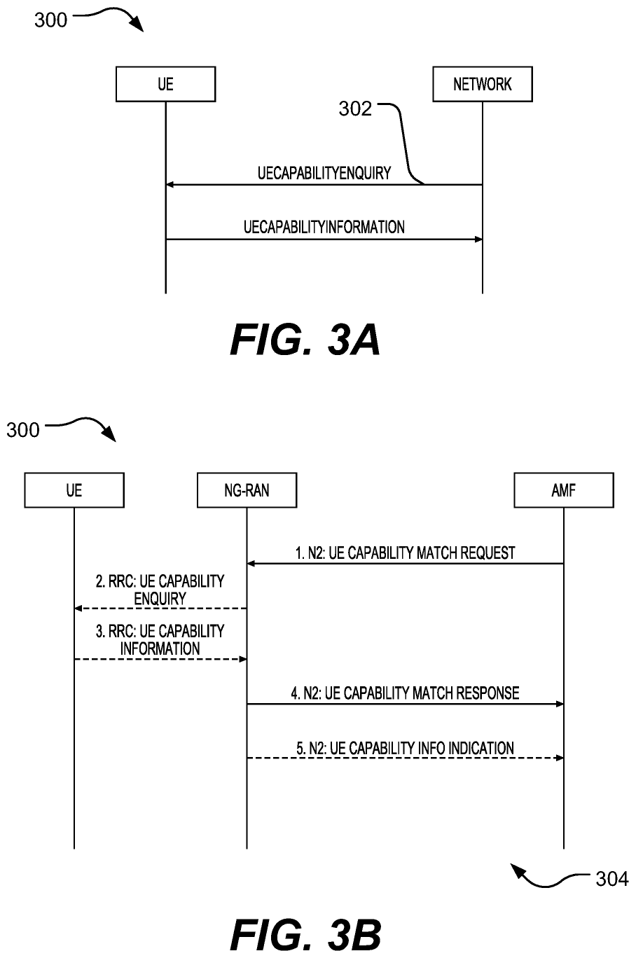

FIGS. 3A and 3B illustrate a system 300 including messaging procedures for improving network performance, which can form at least a portion of the system 100 depicted in FIG. 1.

In some situations, an issue may arise when the MUSIM UE 102 supports MUSIM with more than one active USIM and if the network supports MUSIM enhancements. For instance, in some scenarios, the network may lack an affirmative view of the MUSIM capabilities of the MUSIM UE 102 and network support for MUSIM enhancements. For instance, there may lack an Information Element/Flag for the MUSIM UE 102 to signal to the network that it is a MUSIM capable device. There may lack a mechanism to signal all the MUSIM enhancements supported by the MUSIM UE 102 when more than one USIM is active. Furthermore, there may lack a mechanism for the MUSIM UE 102 to learn of all the MUSIM enhancements supported by the network.

In some examples, the system 300 provides a solution to the issues discussed herein. For instance, the system 300 may leverage the UE Capability Transfer framework as described in 3GPP standard TS 38.331: Section 5.6.1 (e.g., LTE 36.331 Section 5.6.3). For instance, an addition of one or more of the indication(s) 110 in an Information Element (IE) in a UECapabilitylnformation (e.g., UE Capability Information) message 302 may enable the MUSIM UE 102 to explicitly signal its MUSIM capability to the network (e.g., the first network 108 and/or the second network 120). When more than one USIM is active in the MUSIM UE 102, the UECapabilitylnformation message 302 may include an additional IE (e.g., a first IE indicating the active first USIM 114 and a second IE indicating the active second USIM 116) to consolidate multiple supported MUSIM enhancements into a single message (e.g., or multiple messages if the first IE is sent in a first UECapabilitylnformation message 302 and the second IE is sent in a second UECapabilitylnformation message 302.

In some examples, if the MUSIM UE 102 has changed its radio access capabilities, the MUSIM UE 102 can request higher layers to initiate the NAS procedures (e.g., using 3GPP standard TS 23.401) that would result in the update of UE radio access capabilities using a new (e.g., a second) RRC connection. In some instances, the UE Capability Information carries the pure physical layer capability (e.g., UE-Category, Supported Bands, Carrier Aggregation combination etc.). Furthermore, in some instances, a FeatureGroupindicator (FGI) is a special IE within the UE Capability Information message 302 that can carry information about Radio protocol aspects. For example, support for a packet switched (PS) or backwards Handover, transmission time interval (TTI) bundling, Semi-Persistent Scheduling, Handover between frequency division duplex (FDD) and time division duplex (TDD), etc. FGI bits, as described in detail in TS 36.331 Annex B and Annex C, can be included in the UE Capability Information message 302 (e.g., as the one or more indication(s) 110).

In some scenarios, the network is a 4G-LTE network that can use the FGI bits to form the indication(s) 110. The indication(s) 110 can be incorporated into one or more LTE standards, such as LTE (36.306, 36.331), in which UE Capability Information (e.g., with the indication(s) 110) is carried in any of or both of two categories: RF/Physical layer information and FeatureGroup Indicator (FGI). Additionally or alternatively, the network (e.g., the first network 108 and/or the second network 120 can be 3GPP defined network and the indication(s) 110 can be included in Feature Sets defined by the 3GPP standards, such as 4G, 5G, and 6G. The indication(s) 110 can be incorporated into one or more 3GPP defined standards, such as 5G NR (38.306, 38.331): UE Capability Information (e.g., with the indication(s) is carried in any of or both of two categories: RF/Physical layer information and Feature Sets. In 3GPP network environments, a Feature Set can store a set of UE Capabilities and features and/or be modified to include the indication(s) 110. These Feature Set can be assigned an ID, contain a pair for features for UL and DL separately, and/or can be used for NR or E-UTRA. Additionally or alternatively, Using the Feature Set ID, a feature set can be linked/associated with one or more bands within the corresponding band combination. Further with the Feature Set ID, a feature set can be linked/associated within more than one band combination, and/or with the indication(s) 110. The feature set mechanism can be used to ensure that each feature set is reported only once to avoid duplication. In some examples, the system 200 can generate, receive, send, and/or provide an NR feature set to signal the MUSIM feature or capability of the MUSIM UE 102.

FIG. 3B illustrates a UE Capability Match Request procedure 304, which can form at least a portion of the system 100 depicted in FIG. 1. The UE Capability Match Request procedure 304 can be performed in addition or alternatively to the sending the UE Capability Information message 302 discussed herein.

In some instances, the first network 108 can be a 3GPP defined network with the AMF 106 for explicitly leveraging the UE Capability Match Request procedure 304 as discussed herein to request UE MUSIM Capability from the MUSIM UE 102 (e.g., as based on 3GPP standard TS 23.502 Section 4.2.8a). The system 300 may use one or more features of 3GPP Rel-16 to ensure efficient use of network resources and conserve UE battery life, such as Relaxed radio resource management (RRM) measurements. Furthermore, the explicit awareness of the MUSIM capability of the device and the MUSIM enhancements supported, provided by the UE Capability Match Request procedure 304, can help the network (e.g., the first network 108 and/or the second network 120) further optimize the network resources assigned for MUSIM capable devices by customizing UE specific features, parameters, and/or thresholds, such as a different threshold for radio resource management (RRM), discontinuous reception (DRX), and/or carrier aggregation (CA) Configuration and Activation. The aggregated power saving potential of any of the individual enhancements may add up to a significant improvement when taken together.

The UECapabilitylnformation message 302 can be a troubleshooting tool for test engineers. If the MUSIM UE 102 fails in some protocol testing (e.g., a handover, a specific type of measurement, etc.), a test engineer can check this information from the MUSIM UE 102 and check if the enhancements/features are supported. Consolidating the MUSIM Capability and enhancements supported by the MUSIM UE 102 as part of the framework can improve these types of troubleshooting procedures. The UECapabilitylnformation message 302 can be based on one or more 3GPP standards, such as 3GPP TS 23.401; TS 24.301; TS 23.501; TS 23.502; 3GPP TS 38.300; TS 38.306; TS 38.331; TS 36.300; TS 36.306; and/or TS 36.331.

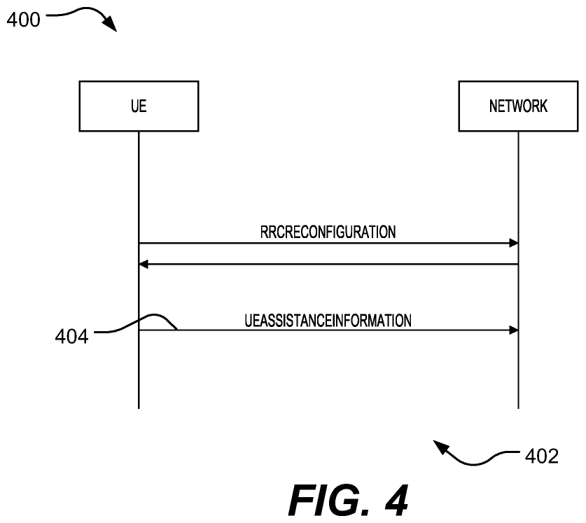

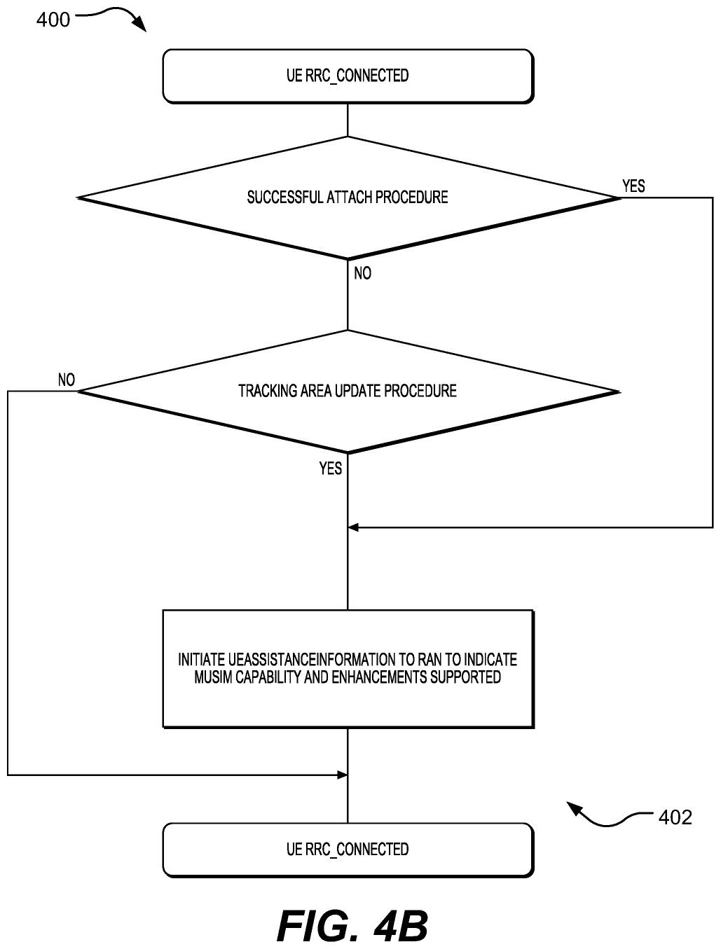

FIGS. 4A and 4B illustrate an example system 400 including a UE Assistance Information Capability procedure 402 for performing communications between the MUSIM UE 102 and the AMF 106 (e.g., to provide the indication(s) 110 to the first network 108).

In some instances, there may be a lack of a signaling mechanism for the MUSIM UE 102 to inform the Network of its MUSIM capability and/or enhancements supported. As such, enhancements may be made to the UE Assistance Information Capability framework 402, as described in 3GPP TS 38.331: Section 5.7.4, to enable the MUSIM UE 102 to signal its MUSIM Capability and supported enhancements. This procedure may cause the MUSIM UE 102 to send one or more messages 404 informing the network of at least one of: a delay budget report carrying desired increment/decrement in the connected mode DRX cycle length; its overheating assistance information; its in-device coexistence (IDC) assistance information; its preference on DRX parameters for power saving; its preference on a maximum aggregated bandwidth for power saving; its preference on a maximum number of secondary component carriers for power saving; its preference on a maximum number of multiple-input/multiple-output (MIMO) layers for power saving; its preference on a minimum scheduling offset for cross-slot scheduling for power saving; its preference on the RRC state; being configured grant assistance information for NR sidelink communication; or its preference in being provisioned with reference time information. Furthermore, the UE Assistance Information Capability procedure 402 may provide a procedure for the MUSIM UE 102 to inform the network of its MUSIM capability and/or supported enhancements if more than one USIM is active. For instance, this indication 110 can be combined with any of the message(s) 404 of the UE Assistance Information Capability procedure 402, and/or sent as an additional message of the UE Assistance Information Capability procedure 402.

As shown in FIG. 4B, the MUSIM UE 102 capable of providing its MUSIM capability and enhancements supported information in RRC_CONNECTED may initiate the procedure (e.g., based on pre-configuration to do so), upon successful completion of Initial Attach/Registration procedure and/or a Tracking Area Update Procedure. By using this 3GPP Rel-16 standard, the system 400 may ensure efficient use of network resources and conserve UE battery life. The explicit awareness of the MUSIM capability of the MUSIM UE 102 and the enhancements it supports, can help the network further optimize the network resources assigned for the MUSIM UE 102 by customizing UE specific features, parameters, and thresholds.

It is to be understood that the specific order or hierarchy of steps in the method(s) discussed and/or depicted throughout this disclosure are instances of example approaches and can be rearranged while remaining within the disclosed subject matter. For instance, any of the operations discussed and/or depicted throughout this disclosure may be omitted, repeated, performed in parallel, performed in a different order, and/or combined with any other of the operations discussed and/or depicted and throughout this disclosure.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method comprising:
sending, by a wireless device to one or more network functions (NF)s of a network, one or more indication that the wireless device is a multi-universal subscriber identity module (MUSIM) device, the one or more indication being included in at least one of:
a user equipment (UE) capability information message of an attach procedure; or
a UE assistance information message of a UE assistance information capability procedure;
receiving, at the wireless device and responsive to the one or more indication, a paging offset request; and
changing, at the wireless device and responsive to the paging offset request, a paging offset value.

2. The method of claim 1, further comprising receiving, at the wireless device and from the one or more NFs, a response message indicating that a MUSIM feature of the MUSIM device is supported by the network.

3. The method of claim 1, wherein the one or more indication includes one or more predefined information elements (IE) of the UE capability information message having one or more predefined values.

4. The method of claim 1, wherein the one or more indication includes a request to activate one or more MUSIM features including at least one of: a connection release request, a paging cause indication support, a reject paging request, paging restriction information, or a paging offset value.

5. The method of claim 4, wherein the one or more indication includes the connection release request to be released to an ECM-IDLE state for one of two USIMS of the wireless device.

6. The method of claim 5, wherein the connection release request is based on the wireless device initiating a Service Request procedure or a Tracking Area Update procedure.

7. The method of claim 1, wherein:
the one or more indication is a first indication of a MUSIM feature being supported by the wireless device; and
the method further comprises:
changing, at the wireless device, one or more device parameters causing a first USIM to be active and a second USIM to be inactive; and
sending, in response to causing the first USIM to be active, a second indication, to the one or more NFs, that that the MUSIM feature is not supported by the wireless device.

8. The method of claim 7, wherein the MUSIM feature is at least one of a Connection Release feature, a Paging Cause Indication for Voice Service feature, a Reject Paging Request feature, or a Paging Restrictions Feature.

9. A method comprising:
sending, by a wireless device to at least one of an Access and Mobility Management Function (AMF) or a Mobility Management Entity (MME), one or more indication that the wireless device is a multi-universal subscriber identity module (MUSIM) device, the one or more indication being included in at least one of:
a user equipment (UE) capability information message of an attach procedure; or
a UE assistance information message of a UE assistance information capability procedure; and
receiving, at the wireless device and responsive to the one or more indication, one or more response messages indicating that the AMF or the MME supports a MUSIM feature of the MUSIM device.

10. The method of claim 9, wherein the one or more response messages are responsive to at least one of:
a connection release request;
an indication Paging Cause Indication for Voice Service is supported;
a paging request rejection;
a requested international mobile subscriber identity (IMSI) Offset value; or
an indication Paging Restriction is supported.

11. The method of claim 9, further comprising changing, at the wireless device, a paging offset value at least partly based on the one or more response messages.

12. The method of claim 9, wherein the one or more indication includes a requested international mobile subscriber identity (IMSI) offset value.

13. The method of claim 12, further comprising receiving, from the one or more NFs, an accepted IMSI offset value, the accepted IMSI offset value being different than the requested IMSI offset value.

14. The method of claim 12, wherein the one or more NFs include a gNodeB.

15. The method of claim 9, wherein sending the one or more indication is at least part of an evolved universal terrestrial radio access network (EUTRAN) initial attach procedure.

16. A method comprising:
receiving, by at least one of an Access and Mobility Management Function (AMF) or a Mobility Management Entity (MME) of a network, one or more indication that a wireless device is a multi-universal subscriber identity module (MUSIM) device, the one or more indication being included in at least one of:
a user equipment (UE) capability information message of an attach procedure; or
a UE assistance information message of a UE assistance information capability procedure;
storing, responsive to the one or more indication, a device identifier, corresponding to the wireless device, associated with a MUSIM feature; and
sending, to the wireless device, an indication that the MUSIM feature is supported by the network.

17. The method of claim 16, wherein the one or more indication that the wireless device is a MUSIM device includes a request for a paging offset.

18. The method of claim 17, further comprising sending, to the wireless device and responsive to the request for the paging offset, an accepted paging offset value.

19. The method of claim 16, further comprising:
receiving an initiation message for a Service Request Procedure or a Tracking Area Update, the initiation message omitting a release indication; and
removing, from a database and in response to the initiation message omitting the release indication, Paging Restriction information associated with the wireless device.

20. The method of claim 16, further comprising:
sending, to the wireless device, a paging message;
determining that the paging message is rejected by the wireless device; and
storing, responsive to the paging message being rejected, and based on the device identifier corresponding to the wireless device being associated with the MUSIM feature, a record that the paging message is rejected due to the MUSIM feature.
